(19) United States
(12) Patent Application Publication
(10) Pub. No.: US 2012/0241555 A1
(43) Pub. Date: Sep. 27, 2012

(54) SUPPORT BLOCK FOR A MOTOR OF A ROTARY WING DRONE

(75) Inventors: Guillaume Savoye, Paris (FR); Yoni Benatar, Les Lilas (FR); Francois Callou, Paris (FR)

(73) Assignee: PARROT, Paris (FR)

(21) Appl. No.: 13/508,972

(22) PCT Filed: Oct. 20, 2010
(86) PCT No.: PCT/FR2010/052230

§ 371 Date: Jun. 14, 2012

(30) Foreign Application Priority Data
Nov. 13, 2009 (FR) 0958013

(51) Int. Cl. B64D 27/26

(52) U.S. Cl. 244/54

(57) ABSTRACT

The support block (130) of each motor of the drone comprises: a support part (131) onto which are fastened an electric motor (120) for driving a propulsion group (100) of the drone, and at least one component (111) of the propulsion group intended to be coupled to the motor; a stand foot (132) for supporting the drone on the ground; and a connection element (133) extending between the support part and the stand foot. The stand foot and the connection element providing together a clearance space (134) for the electric motor during the placement of the motor in its fastening position on the support part.

The present invention relates to a support block for an electric motor for driving a propulsion group of a rotary wing drone.

The invention finds a particularly advantageous application in the field of radio controlled toys that can be used by children, in particular in indoor environments, such as, for example, a room in a house or in a flat.

The CN 201 139 953 Y, CN 201 214 021 Y, US 2004/200924 A1 or WO 2007/052246 A1 describe such radio controlled flying toys with rotary wing.

As used herein, “rotary wing drone” means all the known helicopter formulas, i.e. the conventional mono-rotor formula with anti-torque rotor, the banana-type twin-rotor tandem formula, the Kamof formula with counter-rotating coaxial rotors, and the quadricopter or quadrotor formula with four fixed-pitch rotors, etc.

In a drone of the quadricopter type, for example, the rotary wing is consisted of four propulsion groups, each driven by an electric motor.

Because of their very high rotational speed, the motors used, in particular the brush motors, have a limited service life and have to be frequently changed by the user.

Generally, the motor change operation proves to be tricky because it requires disassembling and reassembling many parts, such as the protective lid in which is enclosed the motor, as well as components of the propulsion group itself, such as the propeller and the system for reducing the rotational speed of the motor.

Therefore, the object of the invention is to propose a support block for an electric motor for driving a propulsion group of a rotary wing drone, of the general type described in the above-mentioned CN 201 139 953 Y, i.e. comprising at least one propulsion group, an electric motor for driving the propulsion group and a support block for the electric motor, which would permit the user of the drone to change the electric motor in a simple and rapid manner without having to disassemble and reassemble parts other than those that strictly ensure the holding of the motor in its operational position.

This object is achieved, according to the invention, by said support block comprising: a support part onto which are fastened the electric motor and at least one component of the propulsion group intended to be coupled to said motor; a stand foot for supporting the drone on the ground; and a connection element extending between the support part and the stand foot, the stand foot and the connection element providing together a clearance space for the electric motor during the placement of said motor in its fastening position on the support part.

Therefore, it is to be understood that, to bring the motor to its operational position, it is just required to manually engage it into the clearance space provided by the stand foot and the connection element until it is placed in its fastening position on the support part, and to fasten it to the support part by means of usual fastening means, such as screws for example.

For the user, there is thus no need to perform complex operations of disassembling and reassembling parts, except unscrewing the fastening screws, removing the motor to be changed through the clearance space and, conversely, to introduce a new motor in the support block through the same clearance space, so as to bring it in its fastening position, and to screw back the fastening screws.

Hence, changing the propulsion group driving electric motor comes down to only change the motor itself, possibly with the control electronic circuit thereof, without the need to also change other components such as the reduction system, the propeller, etc.

Another advantage of the support block, object of the invention, has to be emphasized, which consists in that the support block forms a single part ensuring a double function, i.e., on the one hand, a support for the electric motor, as just described, but also a stand foot for the drone, which avoids providing additional feet on the hull. It results therefrom a simpler implementation, with a smaller area to wind and a reduced mass for the hull.

According to an embodiment of the invention, said connection element comprises two legs connecting the support part to the stand foot and forming a stirrup with the stand foot.

This arrangement permits to provide on the support block, between the foot and the support part, a wide area of access to the motor offering the user a better grip and an easier handling of the motors to be exchanged during the replacement operation.

Advantageously, the invention provides that the component of the propulsion group that is fastened to the support part is consisted by a crown gear of a reduction system of the propulsion group, said crown gear being coupled to the electric motor through a pinion mounted on the axis of the driving electric motor.

This way, a reduced bulkiness of the motor-propulsion group unit and a perfect positioning with respect to the geometry are obtained, so that the pinion of the reduction system is directly borne by the axis of the electric motor.

Finally, according to the invention, the electric motor is fastened to the support part by at least one fastening means arranged outside the crown gear.

As will be seen hereinafter, in this configuration, such fastening means may be made directly accessible, without the user being bothered by components of the propulsion group, and thus without the need to disassemble these components.

An exemplary embodiment of the device of the invention will now be described, with reference to the appended drawings in which same reference numbers designate identical or functionally similar elements throughout the figures.

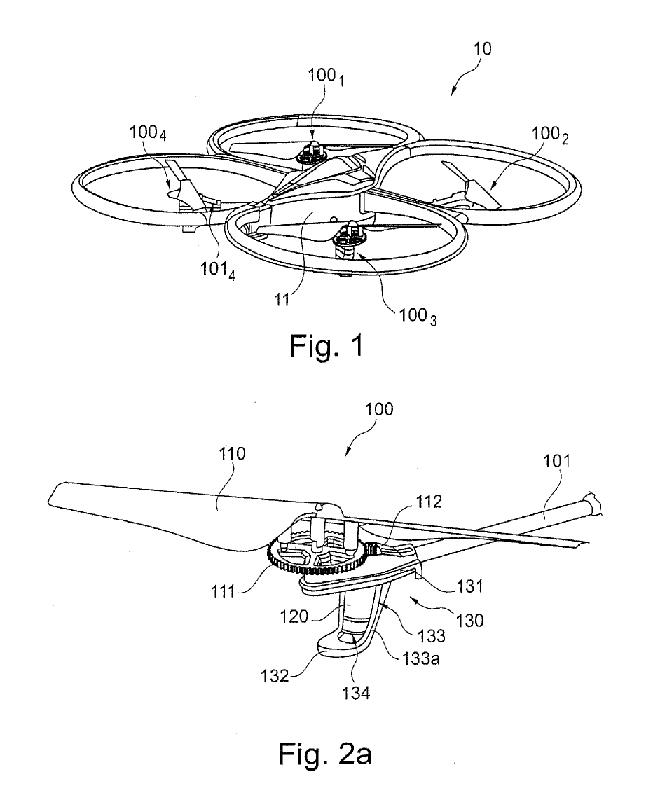

FIG. 1 is a perspective view of a rotary wing drone consisted by a quadricopter.

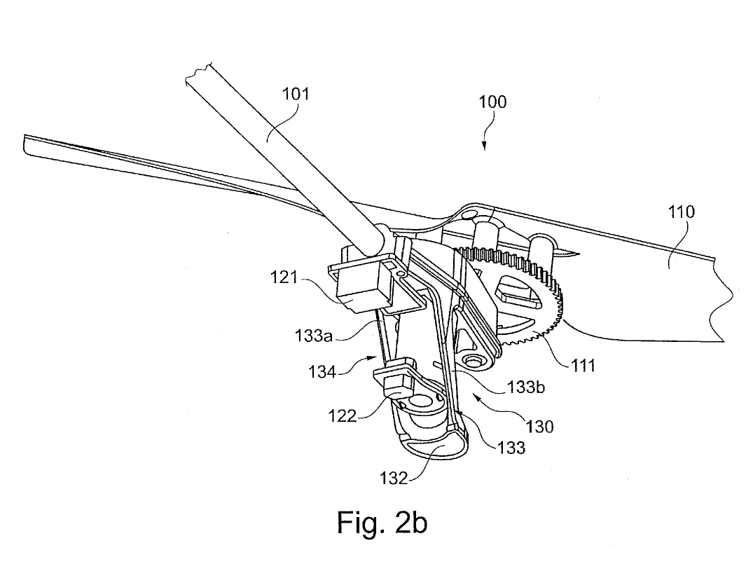

FIG. 2a is a first perspective view of a propulsion group of the quadricopter of FIG. 1.

FIG. 2b is a second perspective view of a propulsion group of the quadricopter of FIG. 1.

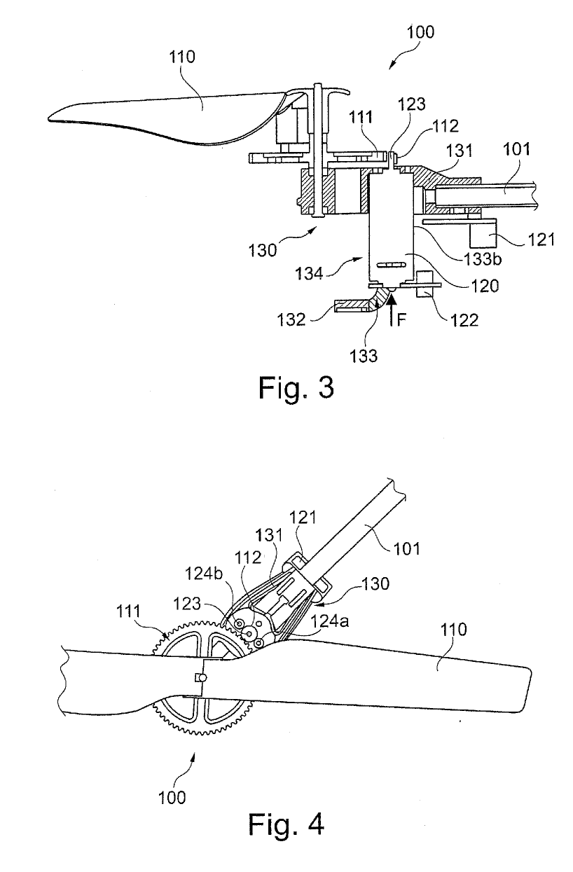

FIG. 3 is a cross-sectional view of the propulsion group of FIGS. 2a and 2b.

FIG. 4 is a top view of the propulsion group of FIGS. 2a and 2b.

In FIG. 1, a quadricopter 10 is shown, constituting a drone whose rotary wing is consisted of four coplanar propulsion groups 100₁, 100₂, 100₃, 100₄, connected to the central structure 11 of the polypropylene hull of the drone 10 by carbon tubes, such as the tube 101₄ that is visible in FIG. 1. As shown in FIGS. 2a, 2b, 3 and 4, a propulsion group, generically referenced by 100, comprises a propeller 110 integral with a crown gear 111, which meshes with a pinion 112 driven by an electric motor 120. The pinion 112 and the crown gear 111 form together a system for reducing the generally very high rotational speed of the electric motor 120.

The carbon tube 101 contains electrical leads that extend between the central structure 11 of the hull and a connector 121 placed at the end of the tube 101, and cables (not shown in the Figures) ensure the electrical connection between the connector 121 and an electronic card 122 of the motor 120. The card 122 may then be powered with direct current from a battery housed in the central structure 11 of the drone and receive control signals for the motor 120, which are established by a navigation electronic card also located in the central structure 11.

The electric motors used may be brush motors that have the advantage to be cheap.

However, their service life is limited by the rotational speeds required, which leads to consider a frequent change of motor; the brush motor being advantageously replaceable, for example, by a brushless motor.

In order to permit a very simple change of the motor 120 with its electronic card 122, without having to disassemble other parts, such as the propeller 110, the crown gear 111, etc., the propulsion group 110 is made around a single part, i.e. a multifunction support block 130 consisted of three elements.

The first element of the support block 130 is a strictly speaking support part 131, onto which are fastened the electric motor 120 as well as the crown gear 111 of the system for reducing the rotational speed of the motor 120. The pinion 112 that meshes with the crown gear 111 is directly fastened to the end of the axis 123 of the motor 120. The support part 131 thus ensures alone the function of assembling the various components of the propulsion group, and this in a very compact manner and with a perfect positioning.

The invention further assigns the support block 130 with another function that consists in providing a stand foot for supporting the drone 10 on the ground when the latter lands or when it is put on the ground. It is for that purpose that the support block 130 comprises a second element formed by a foot 132 connected to the support part 131 by a third connection element 133.

Therefore, it not necessary to provide on the hull feet specifically dedicated for supporting the drone 10 on the ground, hence the above-mentioned advantages of reduced part number, smaller area to wind and reduced weight.

As can be seen in FIGS. 2a, 2b and 3, the stand foot 132 for support on the ground and the connection element 133 provide a clearance space 134 forming a passage for the motor 120 when the latter has to be placed in its fastening position on the support part 131 during the assembling thereof or when it has to be disassembled. It is to be understood that the clearance space 134 offers a direct access to the motor in its fastening position, without disassembling any other part such as a lid or components of the propulsions group. In the example shown in FIG. 3, the introduction of the motor 120 into the clearance space 134 is performed axially, parallel to the direction defined by the arrow F.

On the other hand, the handling of the motor 120 during the assembling and disassembling thereof may also be facilitated by giving to the connection element 133 the form of two legs 133a, 133b forming a stirrup with the stand foot 132. The user of the drone has then a wide area of lateral access to the motor 120, permitting him to correctly hold the latter in hand and to guide it precisely during the replacement thereof.

The fastening of the motor 120 to the support part 131 is itself greatly simplified by means of two screws 124a, 124b, passing through the support part 131 outside the crown gear 111, as indicated in FIG. 4. This position of the fastening screws 124a, 124b is ideal because the access thereto is not hindered by the components of the propulsion group, as the propeller 110 can always be placed in a position that will not hide the screws.

In short, to disassemble a motor 120 that must be replaced, the use has to perform the simple following operations: disconnecting the electronic card 122 from the connector 121, unscrewing the two fastening screws 124a, 124b and removing the unit through the clearance space 134. Conversely, to assemble a new motor, he has to bring the latter in its fastening position through the clearance space 134, screw the two screws 124a, 124b, and connect the electronic card 122 to the connector 121.

1. A rotary wing drone (10), comprising at least one propulsion group (100), an electric motor (120) for driving the propulsion group and a support block (130) for the electric motor,
characterized in that said support block comprises:
a support part (131) onto which are fastened the electric motor and at least one component (111) of the propulsion group intended to be coupled to said motor;
a stand foot (132) for supporting the drone on the ground; and
a connection element (133) extending between the support part and the stand foot,
the stand foot and the connection element providing together a clearance space (134) for the electric motor during the placement of said motor in its fastening position on the support part.

2. A drone according to claim 1, wherein said connection element comprises two legs (133a, 133b) connecting the support part to the foot and forming a stirrup with said stand foot.

3. A drone according to claim 1, wherein said component of the propulsion group fastened to the support part is consisted by a crown gear (111) of a reduction system of the propulsion group, said crown gear being coupled to the electric motor through a pinion (112) mounted on the axis (123) of the driving electric motor.

4. A drone according to claim 3, wherein the electric motor is fastened to the support part by at least one fastening means (124a, 124b) arranged outside said crown gear.
